(19) United States
(12) Patent Application Publication
(10) Pub. No.: US 2003/0048574 A1
(43) Pub. Date: Mar. 13, 2003

(54) Hydrodynamic fluid bearing with gall resistant interface

(75) Inventors: Raquib U. Khan, Pleasanton, CA (US); Chris M. Woldemar, Santa Cruz, CA (US); Mohammad M. Ameen, Campbell, CA (US)

Correspondence Address: Moser, Patterson & Sheridan, LLP, Suite 100, 595 Shrewsbury Avenue, Shrewsbury, NJ, 07702, US

(73) Assignee: Seagate Technology, LLC

(21) Appl. No.: 10/026,377

(22) Filed: Dec. 21, 2001

Related U.S. Application Data
(60) Provisional application No. 60/318,884, filed on Sep. 13, 2001.

(51) Int. Cl. G11B 17/02

(52) U.S. Cl. 360/99.08

(57) ABSTRACT

A disc drive storage system includes a housing having a central axis, a stationary member that is fixed with respect to the housing and coaxial with the central axis, and a rotatable member that is rotatable about the central axis with respect to the stationary member. A hydro bearing interconnects the stationary member and the rotatable member. The hydro bearing components are formed with a gall resistant material to prevent galling between working surfaces of the disc drive system.

### CROSS-REFERENCE TO RELATED APPLICATIONS

This application claims benefit of U.S. provisional patent application serial No. 60/318,884, filed Sep. 13, 2001, which is herein incorporated by reference.

### BACKGROUND OF THE INVENTION

1. Field of the Invention

The present invention relates to the field of hydrodynamic bearing spindle motors for disc drive data storage devices and, more particularly, to a motor having hydrodynamic bearing components with a gall resistant material.

2. Description of the Related Art

Disc drive data storage devices, known as “Winchester” type disc drives, are well-known in the industry. In a Winchester disc drive, digital data is written to and read from a thin layer of magnetizable material on the surface of rotating discs. Write and read operations are performed through a transducer that is carried in a slider body. The slider and transducer are sometimes collectively referred to as a head, and typically a single head is associated with each disc surface. The heads are selectively moved under the control of electronic circuitry to any one of a plurality of circular, concentric data tracks on the disc surface by an actuator device. Each slider body includes a self-acting air bearing surface. As the disc rotates, the disc drags air beneath the air bearing surface, which develops a lifting force that causes the slider to lift and fly several microinches above the disc surface.

In the current generation of disc drive products, the most commonly used type of actuator is a rotary moving coil actuator. The discs themselves are typically mounted in a “stack” on the hub structure of a brushless DC spindle motor. The rotational speed of the spindle motor is precisely controlled by motor drive circuitry, which controls both the timing and the power of commutation signals directed to the stator windings of the motor. Typical spindle motor speeds have been in the range of 3600 RPM. Current technology has increased spindle motor speeds to 7200 RPM, 10,000 RPM and above.

One of the principal sources of noise in disc drive data storage devices is the spindle motor. Disc drive manufacturers have recently begun looking at replacing conventional ball or roller bearings in spindle motors with “hydro” bearings, such as hydrodynamic or hydrostatic bearings. A hydro bearing relies on a fluid film which separates the bearing surfaces and is therefore much quieter and in general has lower vibrations than conventional ball bearings. A hydrodynamic bearing is a self-pumping bearing that generates a pressure internally to maintain the fluid film separation. A hydrostatic bearing requires an external pressurized fluid source to maintain the fluid separation. Relative motion between the bearing surfaces in a hydro bearing causes a shear element that occurs entirely within the fluid film such that no contact between the bearing surfaces occurs.

In a hydro bearing, a lubricant comprising liquid or gas provides a bearing surface between a stationary member of the housing and a rotating member of the disc hub. Typical lubricants include oil or ferromagnetic fluids. Hydro bearings spread the bearing surface over a larger surface area in comparison with a ball bearing assembly, which comprises a series of point interfaces. This is desirable because the increased bearing surface decreases wobble or run-out between the rotating and fixed members.

Although the lubricant is supposed to prevent contact between the bearing surfaces, “galling” between rubbing surfaces may occur. Galling occurs when there is localized welding between two surfaces that rotate relative to each other. Presently, “galling” between surfaces supporting a hydrodynamic bearing can cause catastrophic failure of the disc drive.

Therefore, there exits a need in the art for a hydrodynamic fluid bearing motor having components formed of, or coated with, a gall resistant material.

### SUMMARY OF THE INVENTION

The disc drive data storage system of the present invention includes a housing having a central axis, a stationary member that is fixed with respect to the housing and coaxial with the central axis, and a rotatable member that is rotatable about the central axis with respect to the stationary member. A stator is fixed with respect to the housing. A rotor is supported by the rotatable member and is magnetically coupled to the stator. At least one data storage disc is attached to and is coaxial with the rotatable member. A hydro bearing interconnects the stationary member and the rotatable member. At least one of the hydro bearing components, or a surface layer of at least one of the hydro bearing components, comprises a gall resistant material to reduce galling between the working surfaces in the disc drive data storage system.

### BRIEF DESCRIPTION OF THE DRAWINGS

So that the manner in which the above recited features of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a top plan view of a disc drive data storage device in accordance with the present invention;

FIG. 2 is a sectional view of a hydrodynamic bearing spindle motor in accordance with the present invention;

FIG. 3 is a diagrammatic sectional view of the hydrodynamic spindle motor taken along the line 3-3 of FIG. 2, with portions removed for clarity; and

FIG. 4 is a sectional view of a hydrodynamic bearing with conical bearing surfaces.

### DETAILED DESCRIPTION OF THE PREFERRED EMBODIMENT

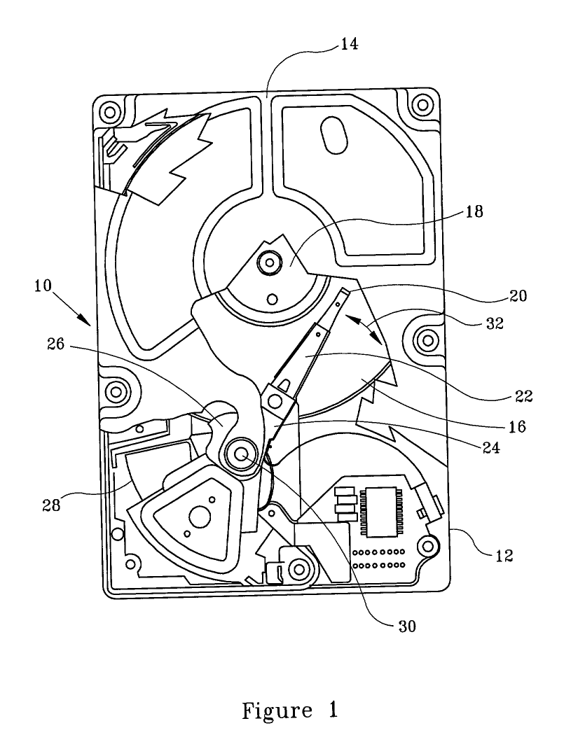

The present invention is a disc drive data storage device having a hydrodynamic or hydrostatic bearing spindle motor having gall resistant components for the unique requirements of a disc drive. FIG. 1 is a top plan view of a typical disc drive 10 in which the present invention is useful. Disc drive 10 includes a housing base 12 that is combined with top cover 14 to form a sealed environment to protect the internal components from contamination by elements from outside the sealed environment.

Disc drive 10 further includes a disc pack 16, which is mounted for rotation on a spindle motor (not shown) by a disc clamp 18. Disc pack 16 includes a plurality of individual discs, which are mounted for co-rotation about a central axis. Each disc surface has an associated head 20, which is mounted to disc drive 10 for communicating with the disc surface. In the example shown in FIG. 1, heads 20 are supported by flexures 22, which are in turn attached to head mounting arms 24 of an actuator body 26. The actuator shown in FIG. 1 is of the type known as a rotary moving coil actuator and includes a voice coil motor (VCM), shown generally at 28. Voice coil motor 28 rotates actuator body 26 with its attached heads 20 about a pivot shaft 30 to position heads 20 over a desired data track along an arcuate path 31. While a rotary actuator is shown in FIG. 1, the present invention is also useful in disc drives having other types of actuators, such as linear actuators.

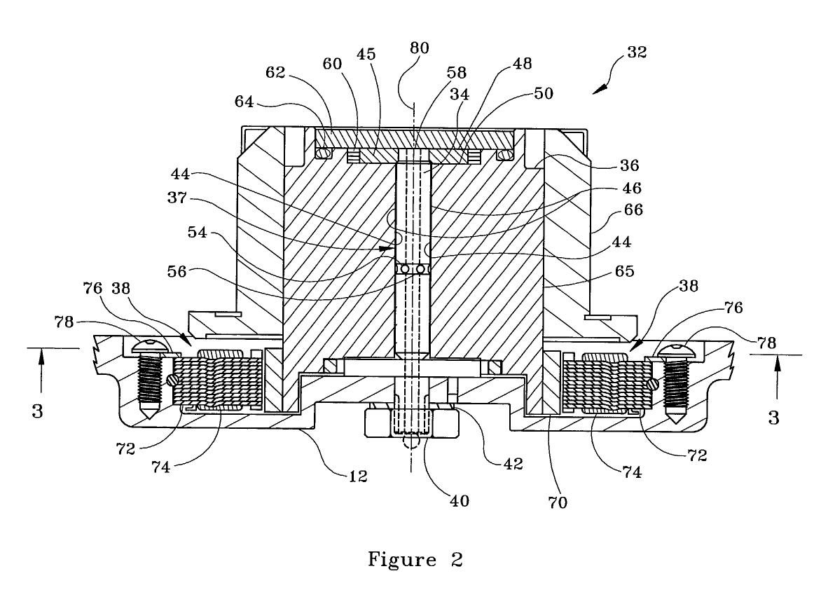

FIG. 2 is a sectional view of a hydrodynamic bearing spindle motor 32 in accordance with the present invention. Spindle motor 32 includes a stationary member 34, a hub 36 and a stator 38. In the embodiment shown in FIG. 2, the stationary member is a shaft that is fixed and attached to base 12 through a nut 40 and a washer 42. Hub 36 is interconnected with shaft 34 through a hydrodynamic bearing 37 for rotation about shaft 34. Bearing 37 includes radial working surfaces 44 and 46 and axial working surfaces 48 and 50. Shaft 34 includes fluid ports 54, 56 and 58 that supply lubricating fluid 60 and assist in circulating the fluid along the working surfaces of the bearing. Lubricating fluid 60 is supplied to shaft 34 by a fluid source (not shown) that is coupled to the interior of shaft 34 in a known manner. Although the present invention is described herein with a lubricating fluid, those skilled in the art will appreciate that the present invention can be used with a lubricating gas.

Spindle motor 32 further includes a thrust bearing 45, which forms the axial working surfaces 48 and 50 of hydrodynamic bearing 37. A counterplate 62 bears against working surface 48 to provide axial stability for the hydrodynamic bearing and to position hub 36 within spindle motor 32. An O-ring 64 is provided between counterplate 62 and hub 36 to seal the hydrodynamic bearing. The seal prevents hydrodynamic fluid 60 from escaping between counterplate 62 and hub 36.

Hub 36 includes a central core 65 and a disc carrier member 66, which supports disc pack 16 (shown in FIG. 1) for rotation about shaft 34. Disc pack 16 is held on disc carrier member 66 by disc clamp 18 (also shown in FIG. 1). A permanent magnet 70 is attached to the outer diameter of hub 36, which acts as a rotor for spindle motor 32. Core 65 is formed of a magnetic material and acts as a back-iron for magnet 70. Rotor magnet 70 can be formed as a unitary, annular ring or can be formed of a plurality of individual magnets that are spaced about the periphery of hub 36. Rotor magnet 70 is magnetized to form one or more magnetic poles.

Stator 38 is attached to base 12 and includes stator laminations 72 and stator windings 74. Stator windings 74 are attached to laminations 72. Stator windings 74 are spaced radially from rotor magnet 70 to allow rotor magnet 70 and hub 36 to rotate about a central axis 80. Stator 38 is attached to base 12 through a known method such as one or more C-clamps 76 which are secured to the base through bolts 78.

Commutation pulses applied to stator windings 74 generate a rotating magnetic field that communicates with rotor magnet 70 and causes hub 36 to rotate about central axis 80 on bearing 37. The commutation pulses are timed, polarization-selected DC current pulses that are directed to sequentially selected stator windings to drive the rotor magnet and control its speed.

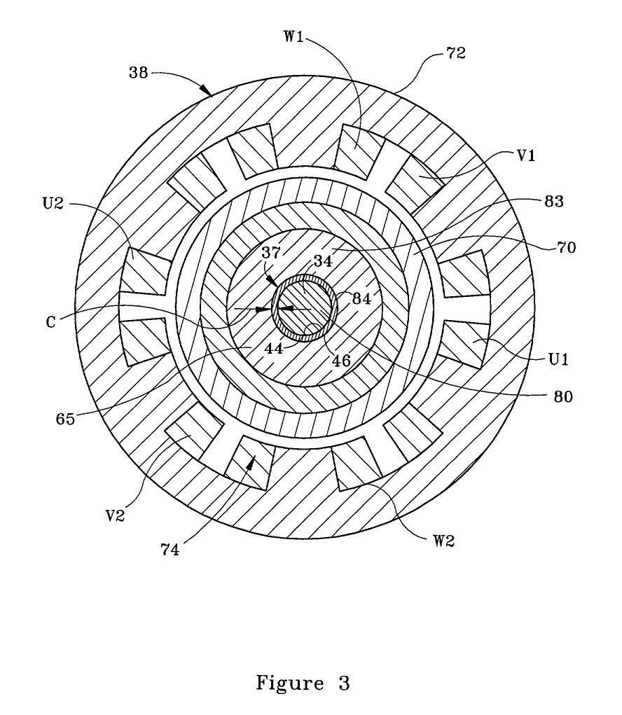

In the embodiment shown in FIG. 2, spindle motor 32 is a “below-hub” type motor in which stator 38 has an axial position that is below hub 36. Stator 38 also has a radial position that is external to hub 36, such that stator windings 74 are secured to an inner diameter surface 82 (FIG. 3) of laminations 72. In an alternative embodiment, the stator is positioned within the hub, as opposed to below the hub. The stator can have a radial position that is either internal to the hub or external to the hub. In addition, the spindle motor of can have a fixed shaft, as shown in FIG. 2, or a rotating shaft. In a rotating shaft spindle motor, the bearing is located between the rotating shaft and an outer stationary sleeve that is coaxial with the rotating shaft.

FIG. 3 is a diagrammatic sectional view of hydrodynamic spindle motor 32 taken along line 3-3 of FIG. 2, with portions removed for clarity. Stator 38 includes laminations 72 and stator windings 74, which are coaxial with rotor magnet 70 and central core 65. Stator windings 74 include phase windings W1, V1, U1, W2, V2 and U2 that are wound around teeth in laminations 72. The phase windings are formed of coils that have a coil axis that is normal to and intersects central axis 80. For example, phase winding W1 has a coil axis 83 that is normal to central axis 80. Radial working surfaces 44 and 46 of hydrodynamic bearing 37 are formed by the outer diameter surface of shaft 34 and the inner diameter surface of central core 65. Radial working surfaces 44 and 46 are separated by a lubrication fluid 60, which maintains a clearance c during normal operation. As described above, a lubricating gas can also be used with the present invention.

As described above, “galling” between working surfaces of the hydrodynamic bearing 37 can result in failure of the disc drive 10. Galling is the localized welding between two surfaces. Galling can occur between the following surfaces: the thrust bearing 45 and the counterplate 62 surfaces; the thrust bearing 45 and the hub 36 surfaces; and the shaft 34 and the hub 36 surfaces. The lubrication fluid 60 is disposed between the surfaces of each of the aforementioned pairs of surfaces. If galling between those working surfaces occurs, the hydrodynamic bearing 37 can fail resulting in catastrophic failure of the disc drive system.

According to one aspect of the present invention, any or all of the working surfaces (radial working surfaces 44 and 46, and axial working surfaces 48 and 50) defined by the thrust bearing 45, the counterplate 62, the hub 36, and the shaft 34 surfaces, are coated with a gall resistant material. Alternatively, any or all of the components defining the working surfaces can be wholly formed of the gall resistant material. The gall resistant material comprises a material such as: phosphor bronze 51000, 51900, 52100, or 52400; silicon bronze; aluminum 4032; an aluminum alloy such as DHT3; nitronic steel 50 or 60; copper-alloy; or aluminum having a diamond-like carbon coating. Moreover, each of the working surfaces can be coated with, or formed of, different gall resistant materials from the other rubbing surfaces.

The gall resistant material has a hardness selected to reduce galling between the working surfaces of the hydrodynamic bearing 37. A gall resistant material having an advantageous hardness can be used directly, or can be brought to the desired hardness during part of the manufacturing process. That is, a gall resistant material with less than the desired hardness can be “cold worked” to bring the gall resistant material to the required hardness. As known to those skilled in the art, cold working is a material reduction or deformation carried out at temperatures below those resulting in the recrystallization or annealing of metal. Cold working of metal will bring about strain-hardening with an increase in strength and hardness.

In one embodiment of the invention, the gall resistant material comprises phosphor bronze 51000 having a desired hardness between 75 and 100 R_{B} on the Rockwell “B” scale. Phosphor bronze 51000 is a commercially available alloy that nominally comprises by weight 94.8% copper, 5% tin, and 0.2% phosphorous. Phosphor bronze 51000 is available having varying hardness ratings from 25 R_{B} for phosphor bronze H0 (i.e., annealed temper) to 100 R_{B} for phosphor bronze H08 (i.e., spring temper). Thus, the thrust bearing 45 and the counterplate 62 can be formed of phosphor bronze 51000 having a hardness rating of H06 (i.e., extra-hard temper), for example, which equates to a hardness of 90-92 R_{B}. In another example, any or all of the rubbing surfaces can be formed of phosphor bronze 51000 having a hardness rating of H0 or H02, and then cold worked to achieve the required hardness between 75 and 100 R_{B}.

Those skilled in the art will appreciate that any combination of working surfaces can be formed of phosphor bronze 51000 having a given hardness to achieve a working surface having the desired hardness between 75 and 100 R_{B}. Moreover, other phosphor bronze alloys can be used having a hardness between 75 and 100 R_{B}, including phosphor bronze 51900, 52100, or 52400. Phosphor bronze 51900 is a commercially available alloy nominally comprising by weight 94.8% copper, 5% tin, and trace amounts of phosphorous. Phosphor bronze 52100 is a commercially available alloy nominally comprising 92% copper, 8% tin, and 0.2% phosphorous. Phosphor bronze 52400 is a commercially available alloy nominally comprising 90% copper, 10% tin, and 0.2% phosphorous.

In another embodiment of the invention, the gall resistant material comprises an aluminum alloy, such as DHT3. DHT3 is commercially available from Kaiser Aluminum and Chemical Company, located in Jackson, Tenn. DHT3 comprises, as a minimum by weight, 90.5% aluminum, 6.5% silicon, 2% copper, and 1% bismuth. Alternatively, DHT3 can comprise as a maximum by weight 77.2% aluminum, 0.2% iron, 5% copper, 0.15% magnesium, 5% bismuth, 0.15% zinc, and 0.2% of other impurities. In accordance with the present invention, a gall resistant material comprising DHT3 has a desired hardness between 80 and 90 B_{HN} on the Brinnel scale.

In yet another embodiment, the gall resistant material comprises aluminum 4032. The desired hardness for aluminum 4032 is between 110 and 130 B_{HN}. Aluminum 4032 is commercially available from Alcoa, Inc., an comprises by weight 11-13.5% silicon, 1% iron, 0.5-1.3% copper, 0.8-1.3% magnesium, 0.1% chromium, 0.5-1.3% nickel, and 0.25-8.0% zinc, with the remaining percentage comprising aluminum. In another embodiment, the gall resistant material comprises nitronic steel (nitronic 32, 40, 50, or 60), which is commercially available from Aramco, Inc. The desired hardness for nitronic steel is between 90 R_{B} and 45 R_{C} (the Rockwell C scale). In yet another embodiment, the gall resistant material comprises 520161 steel, which is commercially available from Carpenter Technology. The desired hardness for 520161 steel is between 90 R_{B} and 45 R_{C}.

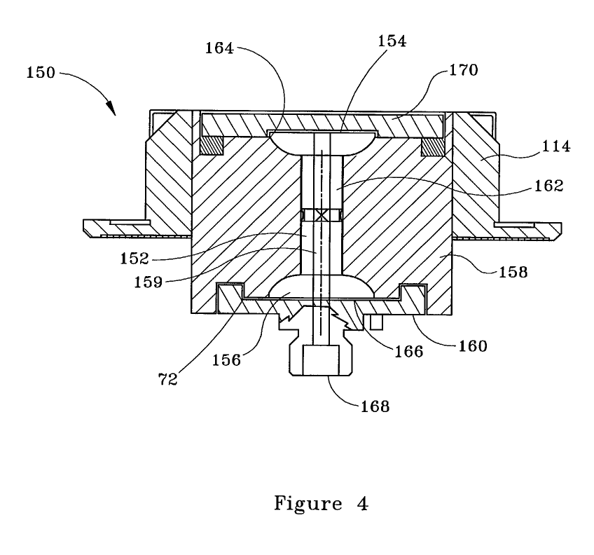

Referring to FIG. 4, a hydrodynamic bearing is shown with conical bearing surfaces, which is usable to drive the discs in the disc drive 10 of FIG. 1. The hydrodynamic bearing is shown incorporated in a spindle motor 150. The design includes a drive rotor or hub 114 rotatably coupled to a shaft 152. The shaft 152 includes an upper hemisphere or convex portion 154 and a lower hemisphere or convex portion 156 received in a sleeve 158 which rotates relative to the shaft. The shaft is fixedly attached to a base 160, which may be incorporated in or supported from the housing base 12 described with respect to FIG. 1. The sleeve 158 receives the journal 162 of shaft 152 and has upper hemisphere shaped, concave receptacle 164 and lower hemisphere shaped concave receptacle 166. A fill hole 168 is also provided to a reservoir 159 in (as drawn, the upper end) fixed member 152, to provide bearing fluid to the hydrodynamic bearing. The rotor 114 includes a counterplate 170, which is used to close off one end of the hydrodynamic bearing to the atmosphere. In operation, the bearings shown in this figure comprise hydrodynamic bearings in which fluid (or gas) such as oil circulates through gaps between the fixed member, which is the shaft and the rotating member, which in this case is the sleeve. One or more of these bearing surfaces may also be coated with, or formed of, a gall resistant material of the present invention as described above.

While foregoing is directed to the preferred embodiment of the present invention, other and further embodiments of the invention may be devised without departing from the basic scope thereof, and the scope thereof is determined by the claims that follow.

1. A disc drive storage system comprising:
a housing having a central axis;
a stationary member that is fixed with respect to the housing and coaxial with the central axis;
a stator fixed with respect to the housing;
a rotatable member that is rotatable about the central axis with respect to the stationary member;
a rotor supported by the rotatable member and magnetically coupled to the stator;
at least one data storage disc attached to and coaxial with the rotatable member;
an actuator supporting a head proximate to the data storage disc for communicating with the disc; and
a hydro bearing interconnecting the stationary member and the rotatable member and having working surfaces separated by a lubricant, wherein at least one of the working surfaces comprises a gall resistant material.

2. The disc drive storage system of claim 1 wherein the gall resistant material is a material selected from the group consisting of phosphor bronze, silicon bronze, aluminum 4032, DHT3, nitronic steel, 520161 steel, copper alloy, and aluminum coated with diamond like carbon.

3. The disc drive storage system of claim 2 wherein the gall resistant material is a phosphor bronze alloy having a hardness between 75 and 100 R_{B} on the Rockwell B scale.

4. The disc drive storage system of claim 2 wherein the gall resistant material is DHT3 having a hardness between 80 and 90 B_{HN} on the Brinnel scale.

5. The disc drive storage system of claim 2 wherein the gall resistant material is aluminum 4032 having a hardness between 110 and 130 B_{HN} on the Brinnel scale.

6. The disc drive storage system of claim 2 wherein the gall resistant material is nitronic steel having a hardness between 90 R_{B} on the Rockwell B scale and 45 R_{C} on the Rockwell C scale.

7. The disc drive storage system of claim 2 wherein the gall resistant material is 520161 steel having a hardness between 90 R_{B} on the Rockwell B scale and 45 R_{C} on the Rockwell C scale.

8. The disc drive storage system of claim 1 wherein the working surfaces are coated with the gall resistant material.

9. The disc drive storage system of claim 1 wherein the working surfaces are formed of the gall resistant material.

10. A motor comprising:
a housing having a central axis;
a stationary member that is fixed with respect to the housing and coaxial with the central axis;
a stator fixed with respect to the housing;
a rotatable member that is rotatable about the central axis with respect to the stationary member;
a rotor supported by the rotatable member and magnetically coupled to the stator; and
a hydro bearing interconnecting the stationary member and the rotatable member and having working surfaces separated by a lubricant, wherein at least one of the working surfaces comprises a gall resistant material.

11. The motor of claim 10 wherein the gall resistant material comprises a phosphor bronze alloy having a hardness between 75 and 100 R_{B} on the Rockwell B scale.

12. The motor of claim 10 wherein the gall resistant material comprises DHT3 having a hardness between 80 and 90 B_{HN} on the Brinnel scale.

13. The motor of claim 10 wherein the gall resistant material comprises aluminum 4032 having a hardness between 110 and 130 B_{HN} on the Brinnel scale.

14. The motor of claim 10 wherein the gall resistant material is nitronic steel having a hardness between 90 R_{B} on the Rockwell B scale and 45 R_{C} on the Rockwell C scale.

15. The motor of claim 10 wherein the gall resistant material is 520161 steel having a hardness between 90 R_{B} on the Rockwell B scale and 45 R_{C} on the Rockwell C scale.

16. A motor comprising:
a housing having a central axis;
a stationary member that is fixed with respect to the housing and coaxial with the central axis;
a stator fixed with respect to the housing;
a rotatable member that is rotatable about the central axis with respect to the stationary member;
a rotor supported by the rotatable member and magnetically coupled to the stator;
a hydro bearing interconnecting the stationary member and the rotatable member and having working surfaces separated by a lubricant; and
means for reducing galling between at least two of the working surfaces.

17. The motor of claim 16 wherein the means for reducing galling is included in at least one of the working surfaces and comprises a phosphor bronze alloy having a hardness between 75 and 100 R_{B} on the Rockwell B scale.

18. The motor of claim 16 wherein the means for reducing galling is included in at least one of the working surfaces and comprises DHT3 having a hardness between 80 and 90 B_{HN} on the Brinnel scale.

19. The motor of claim 16 wherein the means for reducing galling is included in at least one of the working surfaces and comprises aluminum 4032 having a hardness between 110 and 130 B_{HN} on the Brinnel scale.

20. The motor of claim 16 wherein the means for reducing galling is included in at least one of the working surfaces and comprises nitronic steel having a hardness between 90 R_{B} on the Rockwell B scale and 45 R_{C} on the Rockwell C scale.
